(19) United States
(12) Patent Application Publication
(10) Pub. No.: US 2003/0233340 A1
(43) Pub. Date: Dec. 18, 2003

(54) System and method for sorting data

(76) Inventors: Miroslaw A. Flasza, Pickering (CA); David C. Sharpe, Mountain View, CA (US)

Correspondence Address: SAWYER LAW GROUP, P.O. Box 51418, Palo Alto, CA, 94303, US

(21) Appl. No.: 10/421,176

(22) Filed: Apr. 22, 2003

(30) Foreign Application Priority Data
Jun. 18, 2002 (CA) 2,390,849

(51) Int. Cl. G06F 7/00

(52) U.S. Cl. 707/1

(57) ABSTRACT

A method for ordering a first and a second character string is disclosed. The method comprises determining which of the two character strings has a lower collating weight according to a first dictionary sort order table with a non-unique collating sequence, and determining which of the two character strings has a lower collating weight according to a second dictionary sort order table with a unique collating sequence.

### CROSS-REFERENCE TO RELATED APPLICATIONS

This application claims benefit under 35 USC §119 of Canadian Application No. 2,390,849, filed on Jun. 18, 2002.

### FIELD OF THE INVENTION

The present invention relates to a system and method for sorting data. More particularly, the invention relates to sorting character data into equivalence classes and within equivalence classes.

### BACKGROUND OF THE INVENTION

Sorting character data is a common operation performed by computer systems. The English language, like many languages, makes use of multiple forms of letters in an alphabet. Each English letter has an uppercase form and a lowercase form. Various grammatical rules require the use of the uppercase and lowercase letters in particular circumstances in written English. In addition, writers may elect to use uppercase and lowercase letters to emphasize words or for other reasons. The use of uppercase or lowercase letters does not normally affect the meaning of an English word, and all variations of the English word are generally considered to be equivalent to one another.

Words are often sorted alphabetically based on a standard dictionary sort order, without regard to whether they are written using uppercase letter, lowercase letter or a mixture of uppercase and lowercase letters. For example, the words “Chad”, “CHAD” and “chad” are generally considered equivalent by most readers. Any version of the word “alpha” would be alphabetized before any version of the word “chad”, and any version of the word “delta” would be alphabetized after any version of the word “chad”. The three versions of the word “chad”, as well as other versions such as “cHAd”, can be said to be in a single equivalence class, when words are organized alphabetically. Within such an equivalence class, one typical method of alphabetizing different forms of a word is to give precedence to an uppercase letter over a lowercase letter. Accordingly, the three versions of “chad” above may be ordered as follows: “CHAD”, then “Chad”, and then “chad”.

Computer systems use character sets that are used to form coded character strings to represent words. Typically, a character set will include different characters for each form of a letter. A common character set used by digital computers is the ASCII character set which provides distinct coded characters for representing all uppercase forms of letters and distinct coded characters for representing all lowercase forms of letters. To the digital computer system, the different coded characters (“coded character” is hereinafter referred to as “character”) are unrelated to one another, and character strings formed using the different characters are seen by the computer system as distinct from one another.

A computer system would see the three character strings “Chad”, “CHAD” and “chad” as distinct from one another. As a result, the computer system may not alphabetize the character string “alpha” before the character string “CHAD”. The computer system may also not alphabetize the character string “DELTA” after the character string “chad”. In general, the computer system cannot use its basic character set to sort words in the same way that a person would. To allow computers to group different forms of the same word, dictionary sort order tables are defined to map the dictionary sort order to the order of characters in the computer system's character set.

Dictionary sort order tables may have a unique collating sequence that allows all character strings to be distinguished from one another and organized in a desirable sequence, such as the alphabetic sequence described above. Such sort order tables have the problem that they cannot be used to identify character strings that are in the same equivalence class, i.e. they are different forms of the same word using different combinations of uppercase and lowercase letters.

Other dictionary sort order tables have a non-unique collating sequence that allows character strings in the same equivalence class to be identified, but they cannot be used to order the strings in a desirable order within an equivalence class.

Accordingly, a solution that addresses, at least in part, this and other shortcomings is desired.

### SUMMARY OF THE INVENTION

The present invention is directed to a method for ordering a first and a second character string. The method comprises determining which of the two character strings has a lower collating weight according to a first dictionary sort order table with a non-unique collating sequence, and determining which of the two character strings has a lower collating weight according to a second dictionary sort order table with a unique collating sequence.

Through aspects of the present invention, character data is sorted by equivalence classes as well as within equivalence classes. In one embodiment, the second determining step is performed only if the first and second character strings are found, during the first determining step, to be members of the same equivalence class. The second determining step identifies which of the two character strings should be presented first.

A better understanding of these and other embodiments of the present invention can be obtained with reference to the following drawings and description of the preferred embodiments.

### BRIEF DESCRIPTION OF THE DRAWINGS

An exemplary embodiment of the present invention will now be described with reference to the accompanying drawings, in which:

FIG. 1 illustrates a portion of the ASCII character set widely used in computer systems;

FIG. 2 illustrates a dictionary sort order table with a unique collating sequence;

FIG. 3 illustrates a dictionary sort order table with a non-unique collating sequence;

FIG. 4 illustrates a system including a comparison module according to the present invention; and

FIGS. 5 and 6 illustrate a method according to the present invention.

### DETAILED DESCRIPTION

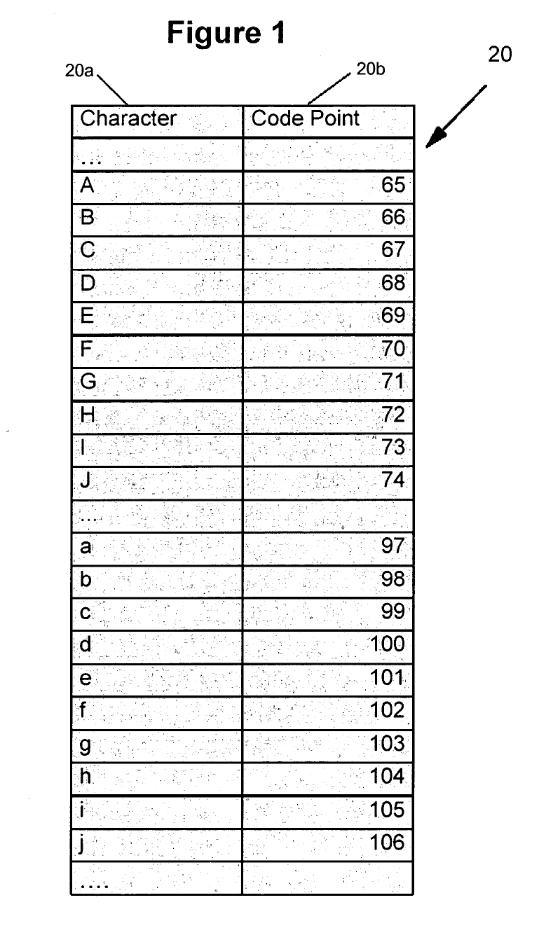

Reference is first made to FIG. 1. Alphabetic characters 20a are represented in computer memory by numbers defined by a character set. A common example of a character set is the ASCII character set 20, a portion of which is illustrated in FIG. 1. The ASCII character set 20 uses 8 bit numbers between 0 and 255 to represent alpha-numeric characters, control characters and other characters. Other character sets may have more than 256 characters, requiring the use of numbers with more than 8 bits. Each character in the character set 20 has a unique number, which may be referred to as the character's code point 20b.

ASCII character set 20 includes characters for the Roman letters that are generally used for the English language and other languages. The alphabet of most languages is typically presented in a standardized dictionary sort order. This dictionary sort order defines the weight of each letter in the alphabet to be used when sorting letters in the alphabet. In the dictionary sort order, a letter with a lower weight precedes a letter with a higher weight. The dictionary sort order for a particular alphabet can depend on the particular language and, in some cases, the geographic territory in question. In some languages a single letter may have more than one representation. For example, in English, each letter has an uppercase and a lowercase form. In the dictionary sort order of the English alphabet, the uppercase and a lowercase form of each letter are given the same weight.

The order of characters in a computer character set, such as ASCII character set 20, will typically be different from the dictionary sort order for the letters that are included in the character set. To sort the characters in the computer character set consistently with the dictionary sort order for the alphabet in use, computer programs use dictionary sort order tables that provide a mapping between the character code points 20b in the character set and the letter weights in the dictionary set order. Known dictionary sort order tables may have a unique collating sequence or a non-unique collating sequence.

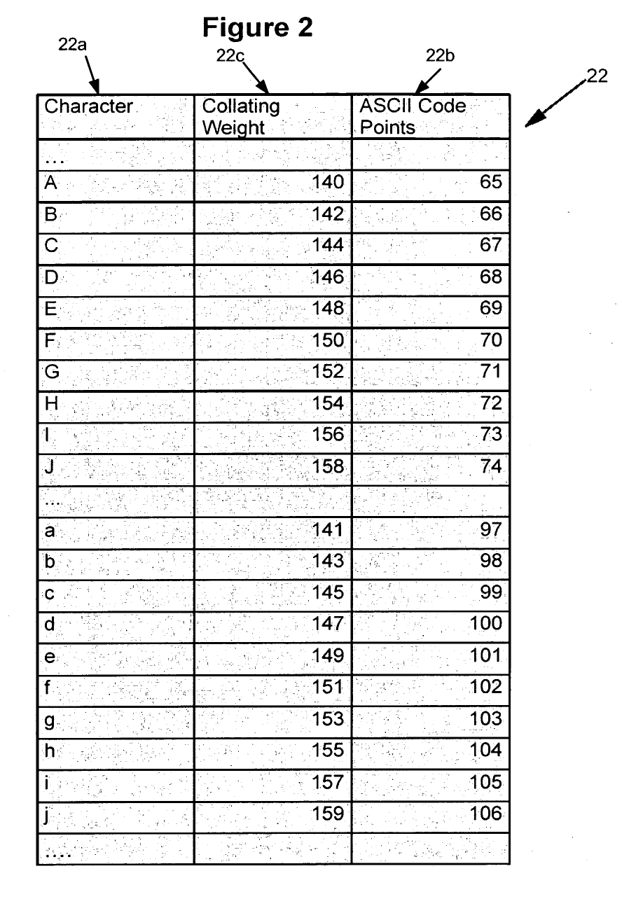

FIG. 2 illustrates a dictionary sort order table 22 with a unique collating sequence. In a dictionary sort order table with a unique collating sequence each character 22a in the computer character set is assigned a unique collating weight 22c based on the weights assigned to corresponding letters in the dictionary sort order of the relevant language. Since all characters are assigned unique weights 22c, different forms of the same letter are often assigned consecutive or effectively consecutive weights. Typically, the uppercase form of an English letter is considered to have a lower weight than its corresponding lowercase form. Dictionary sort order table 22 follows this rule, but could follow the opposite rule. In dictionary sort order table 22, the uppercase “D” is assigned a weight of 146 and the lowercase “d” is assigned a higher weight of 147.

A single word, such as “chad” may be written in various combinations of uppercase and lowercase letters. In a computer, such combinations are usually referred to a character strings. Two different character strings corresponding to the word “chad” are “CHAD” and “Chad”. When character strings are sorted using dictionary sort order table 22 with a unique collating sequence, uppercase and lowercase forms of the same letter 22a have different weights. By comparing successive pairs of letters in a pair of strings, one of the strings may be determined to have a lower collating weight, unless the strings are identical. For example, the character string “CHAD” can be determined to have a lower collating weight that the character string “Chad”. Initially, the first letter of each string is compared. Each string begins with an uppercase C so these letters have equal weight 22c (144). Then the next letter of each string is compared. Since the uppercase H in “CHAD” has a lower weight (154) than the lowercase h in Chad (which has a weight of 155), the character string “CHAD” has a lower collating weight than the character string Chad according to dictionary sort order table 22.

As noted above, the character strings “CHAD” and Chad (as well as “chad”, etc.) are typically considered to be the same word in the English language. These character strings can be said to be in an “equivalence class”. By sorting them with dictionary sort order table 22, the two different character strings have been distinguished and sorted, but the fact that they are in the same equivalence class (i.e. they are the same English word) has been lost. This type of sort may be referred to as a “case-sensitive” sort.

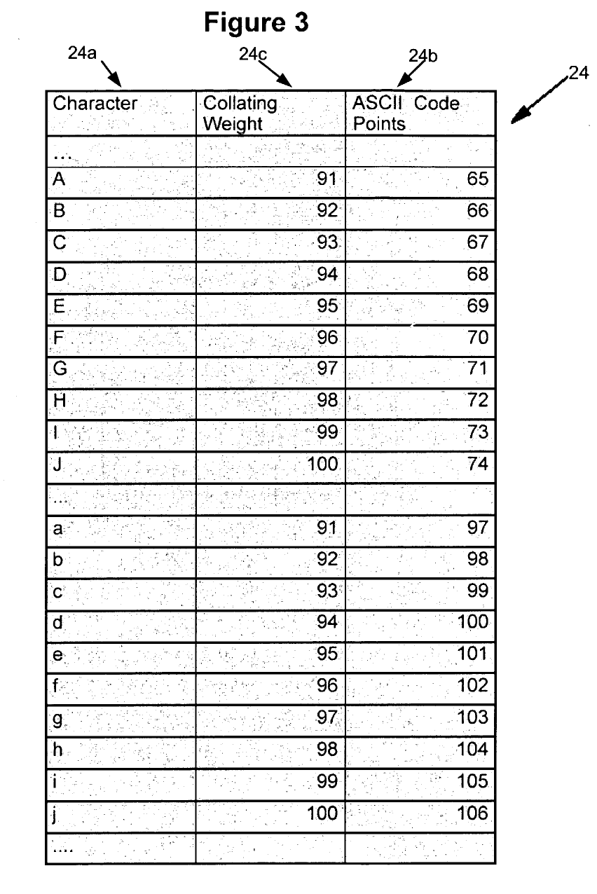

FIG. 3 illustrates a dictionary sort order table 24 with a non-unique collating sequence. In a dictionary sort order table 24 with a non-unique collating sequence each character 24a corresponding to the same letter is assigned the same collating weight 24c, based on the weight of the letter in the dictionary sort order for the language in use. Accordingly, both the uppercase “A” and lowercase “a” are assigned the same collating weight 24c in dictionary sort order table 24.

When the character strings “CHAD” and Chad are sorted using dictionary sort order table 24, they are determined to be in the same equivalence class, because each corresponding pair of letters in both strings has the same weight. These and other character strings, such as “chad”, cHad, chAD) are all in the same equivalence class and dictionary sort order table 24 does not distinguish between them. As a result, they could be sorted in any arbitrary order. As noted above, in many cases it is preferable to list these strings in the order “CHAD”, Chad. This may be desirable to provide an aesthetically pleasing list for a report. In other cases, the opposite order may be preferable.

By sorting these character strings using dictionary sort order table 24 with a non-unique collating sequence, the fact that both character strings “CHAD” and Chad are the same English word and in the same equivalence class is recognized but the desired sort order of the character strings (within the equivalence class) themselves is ignored. This type of sort may be referred to as a “case-insensitive” sort.

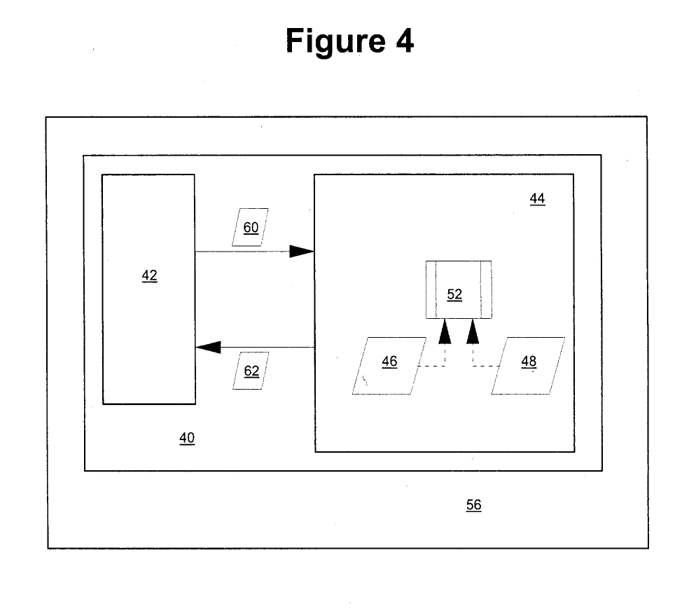

Reference is next made to FIG. 4 which illustrates a system 40 that allows different character strings to be sorted in a desirable sequence, including character strings that represent the same word. System 40 includes a sorting module 44, a dictionary sort order table 46 with a non-unique collating sequence and a dictionary sort order table 48 with a unique collating sequence. Sorting module 44 also includes a comparison module 52. Alternatively, comparison module 52 may be separate from sorting module 44 and may include a function call to allow sorting module 44 to access comparison module 52.

In this exemplary embodiment of the present invention, dictionary sort order table 46 is identical to dictionary sort order table 24 (FIG. 3) and dictionary sort order table 48 is identical to dictionary sort order table 22 (FIG. 2). Dictionary sort order table 46 is chosen to allow equivalence classes of English language character strings to be distinguished from one another, without providing any distinction between character strings that are in the same equivalence class. Dictionary sort order table 48 is chosen to allow character strings within an equivalence class to be distinguished from one another. In other embodiments of the invention, other dictionary sort order tables may be used depending on the dictionary sort order for the language in use or on the specific distinctions to be made between equivalence classes and elements within equivalence classes.

System 40 may be used to provide data sorting services to a calling program 42. Alternatively, system 40 may be part of a database management system (not shown) and may provide data sorting services to the database management system. Typically, system 40 will be installed in a computer system 56. Computer system 56 may include more than one computer, storage devices and other elements. The components of system 40 may be distributed in different parts of computer system 56.

Sorting module 44 is configured to receive an unsorted input data set 60 from calling program 42. Input data set 60 may be any type of character string data in which any particular datum may include different forms of letters or other symbols that could be given an equal weight in a dictionary sort order, but for which a preferred order of sorting may be defined. An exemplary input data set 60 comprises the five data character strings: chad, Alpha, CHAD, delta, and Chad. This exemplary input data set 60 will be used to explain the operation of system 40.

Sorting module 44 sorts the data in input data set 60 into their equivalence classes according to dictionary sort order table 46 and within their equivalence classes according to dictionary sort order table 48 to produce an output data set 62. Output data set 62 is returned to calling program 42.

To sort input data set 60 to produce output data set 62, sorting module 44 may implement any sorting algorithm such as bubble sort, quick sort, insertion sort, etc. During each iteration of the sorting algorithm, sorting module 44 passes two data from input data set 60 to comparison module 52. In response, comparison module 52 returns a first return value R1 to sorting module 44. The first return value R1 is based on a comparison of the two datum based on dictionary sort order table 46. If the two datum are equal (i.e. they are in the same equivalence class) when compared according to dictionary sort order table 46, comparison module 52 also returns a second return value R2 to sorting module 44. The second return value R2 is based on a comparison of the two datum based on dictionary sort order table 48. During successive iterations of the sorting algorithm, sorting module 44 will receive a series of return values R1 and R2 from comparison module 52.

Sorting module 44 sorts the data in input data set 60 into a single list in which (i) equivalence classes are sorted and grouped together based on the series of return values R1 and (ii) data within equivalence classes are ordered into a desirable order based on the series of return values R2. The sorted data forms output data set 62, which is returned to the calling program 42 when input data set 60 has been fully sorted.

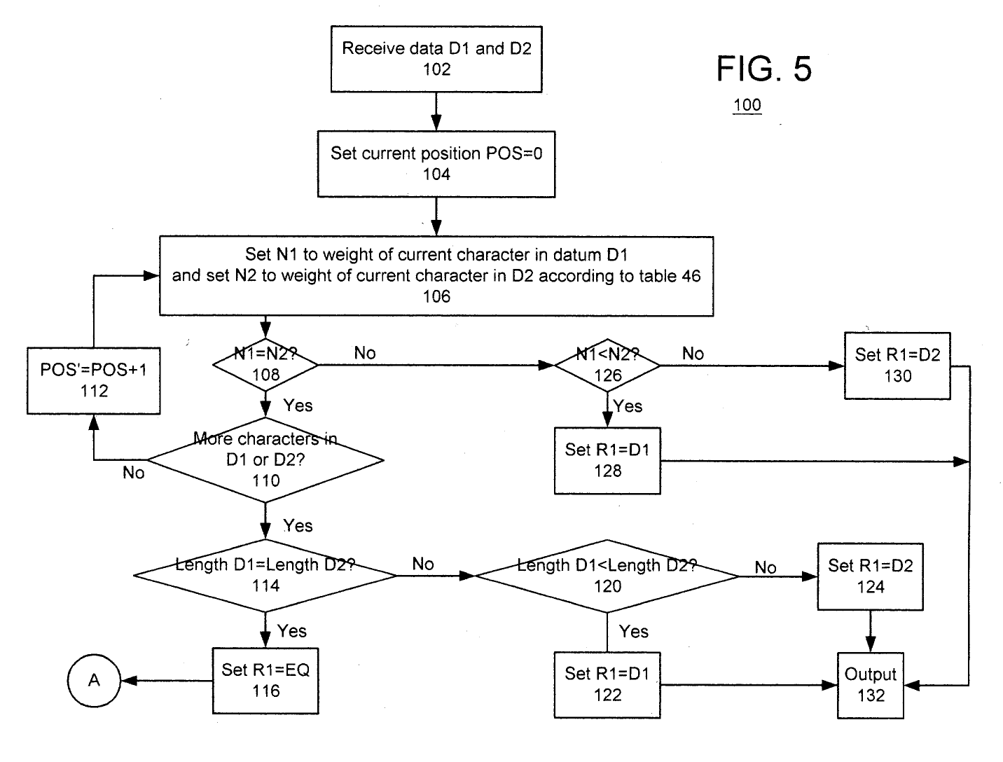

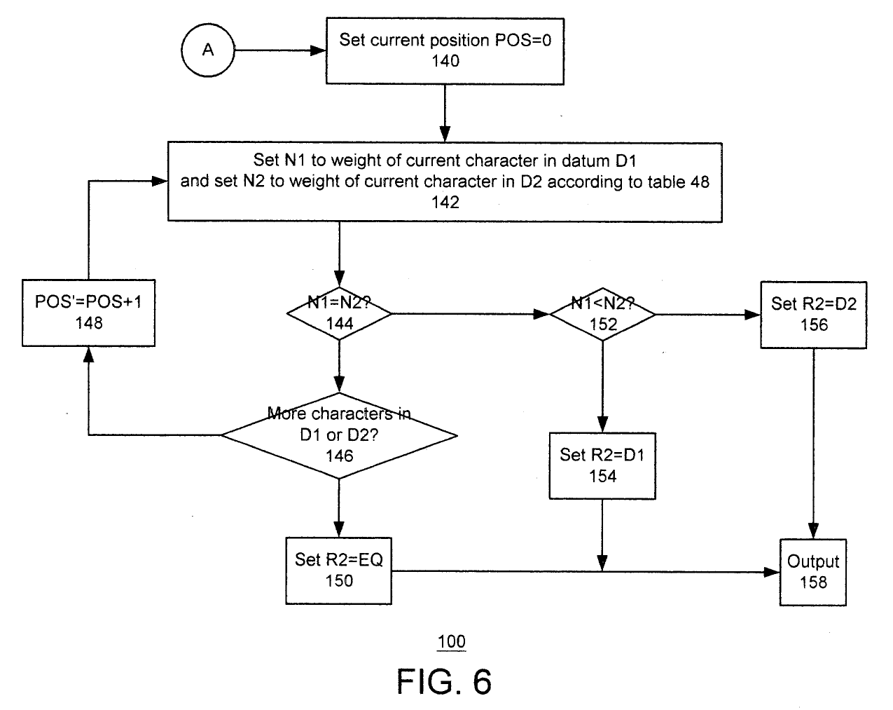

Reference is next made to FIGS. 4, 5 and 6. FIGS. 5 and 6 illustrate a method 100 for sorting data according to a preferred embodiment of the present invention. Method 100 illustrates the operation of comparison module 52. Method 100 will be explained using an example in which two of the data in input data set 60, character strings CHAD and Chad, are compared to each other.

Method 100 begins in step 102 in which sorting module 44 receives a pair of data D1 and D2 from calling program 42. For example, D1 may be character string CHAD and D2 may be character string Chad. Method 100 proceeds to step 104, in which a current position counter POS is set to 0. A skilled person will understand that the characters in a character string having a length of M characters are typically referred to as being in positions 0, 1, 2, . . . , M−1. Accordingly, when the current position counter equals 0, the first character of the character string is at the current position. Alternatively, the current position counter POS could be initialized to 1 in step 104 and the positions of each character string may be numbered 1, 2, 3, . . . , M.

Method 100 proceeds to step 106. In step 106, a variable N1 is set equal to the weight of the character in the current position of datum D1, according to dictionary sort order table 46, which has a non-unique collating sequence. For example, the character in the current position of datum D1 is “C” and N1 is thus equal to 93 (See FIG. 3). In addition, a variable N2 is set equal to the weight of the character in the current position of datum D2. The character in the current position of datum D2 is “C” and N2 is thus also set to 93.

Next, in step 108, the values of N1 and N2 are compared. If N1 is equal to N2, then method 100 proceeds to decision step 110. If N1 is not equal to N2, then method 100 proceeds to step 126. In the former, i.e., where N1=N2, decision step 110 determines if the character at the current position of datum D1 is the last character of datum D1 or if the character at the current position of datum D2 is the last character of datum D2. If the decision is affirmative, then method 100 proceeds to decision step 114. Otherwise, there is at least one more character in each of datum D1 and datum D2 and method 100 proceeds to step 112. In step 112, the current position pointer POS is incremented and method 100 returns to step 106.

In the present example, method 100 will loop through steps 106, 108 and 110 four times and step 112 three times while the successive characters in datum D1 (CHAD) and datum D2 (Chad) are compared. Because variables N1 and N2 are set in step 106 using dictionary sort order table 46, which has a non-unique collating sequence with uppercase and lowercase forms of each letter having the same weight, method 100 will reach the ends of datum D1 and D2 on the fourth iteration through step 110. At that point, method 100 will proceed to step 114.

In decision step 114, the lengths of datum D1 and D2 are compared. If their lengths are equal, then method 100 proceeds to step 116. Otherwise, method 100 proceeds to decision step 120.

In step 116, return value R1 is set to EQ, indicating that data D1 and D2 are members of the same equivalence class according to dictionary sort order table 46. Data D1 and D2 will be in the same equivalence class if they have the same number of characters and if each corresponding letter of each datum D1 and D2 have the same weight according to dictionary sort order table 46. Method 100 proceeds to step 140 (FIG. 6). In the present example, method 100 will proceed through step 116 to step 140, because datum D1 and datum D2 are of equal length.

From decision step 120, method 100 proceeds to step 122 if the length of datum D1 is less than the length of datum D2. In step 122, return value R1 is set to “D1”, indicating that datum D1 has a lower weight than datum D2. If the length of datum D1 is longer than the length of datum D2, then method 100 proceeds to step 124. In step 124, return value R1 is set to “D2”, indicating that datum D2 has a lower weight than datum D1. Method 100 then proceeds to step 132.

Step 114, 116, 120 and 122 implement a rule that if one of the datum is longer than the other, but no difference in the weight of corresponding character is found in any iteration of step 108, then the shorter datum is deemed to have a lower collating weight. In another embodiment, the longer datum may be deemed to have a lower collating weight. In another embodiment, differences in the length of data D1 and D2 may be ignored and method 100 may proceed directly from step 110 to step 116 if the end of datum D1 or D2 has been reached. In such an embodiment, steps 114, 120 and 122 would not exist.

In step 126, the weights N1 and N2 of the characters in the current position of data D1 and D2 are compared. If N1 is less than N2, then method 100 proceeds to step 128. In step 128, return value R1 is set to “D1”, indicating that datum D1 has a lower weight than datum D2, when they are compared according to dictionary sort order table 46. If N2 is greater than N1, then method 100 proceeds to step 130. In step 130, return value R1 is set to “D2”. Method 100 then proceeds to step 132. In step 132, method 100 returns return value R1 to calling program 42 and then ends.

Reference is now made to FIG. 6. If method 100 reaches step 140, i.e., when R1=EQ, then data D1 and D2 are equal when compared according to dictionary sort order table 46 and they have the same length. In the following steps, data D1 and D2 are compared according to dictionary sort order table 48, which has a unique collating sequence. This allows uppercase and lowercase forms of the same letter to be distinguished and allows character strings within the same equivalence class to be ordered based on the unique collating weights defined in dictionary sort order table 48.

In step 140, current position counter POS is set to 0. Method 100 proceeds to step 142. In step 142, variable N1 is set equal to the weight of the character in the current position of datum D1, according to dictionary sort order table 48. In the example, the character in the current position of datum D1 is an uppercase “C” and N1 is thus set equal to 144. Variable N2 is set equal to the weight of the character in the current position of datum D2. The character in the current position of datum D2 is also an uppercase “C” and N2 is also set to 144.

Method 100 next proceeds to decision step 144, in which the values of N1 and N2 are compared. If N1 is equal to N2, then method 100 proceeds to decision step 146, where it is determined if the character at the current position of datum D1 is the last character of datum D1 or if the character at the current position of datum D2 is the last character of datum D2. If the decision in step 146 is affirmative, then method 100 proceeds to step 150. Otherwise, there is at least one more character in each of datum D1 and datum D2 and method 100 proceeds to step 148. In step 148, the current position pointer POS is incremented and method 100 returns to step 142.

In step 150, return value R2 is set to EQ, indicating that data D1 and D2 are equal according to dictionary sort order table 48. Data D1 and D2 will be equal if each corresponding pair of letters in each of them is the same form (uppercase or lowercase) of the same letter. Method 100 then proceeds to step 158.

In the present example, method 100 will loop through steps 142 and 144 twice and steps 146 and 148 once while the successive characters in datum D1 (CHAD) and datum D2 (Chad) are compared. Variables N1 and N2 are set in step 142 using dictionary sort order table 48, which has an unique collating sequence with uppercase and lower case forms of each letter having distinct weights. When the position counter is incremented to 1, variables N1 and N2 will be set based on the second character in datum D1 and datum D2, respectively. The second character in datum D1 is an uppercase “H” and the value of N1 is set to 154. The second character of datum D2 is a lowercase “h” so the value of N2 is set to 155. When method 100 reaches step 144 for the second time, method 100 will proceed to step 152, because N1 will not be equal to N2.

In step 152, the weights N1 and N2, according to dictionary sort order table 48, of the characters in the current position of data D1 and D2 are compared. If N1 is less than N2, then method 100 proceeds to step 154. In step 154, return value R2 is set to “D1”, indicating that datum D1 has a lower weight than datum D2, according to dictionary sort order table 48. If N2 is greater than N1, then method 100 proceeds to step 156. In step 156, return value R2 is set to “D2”. Method 100 then proceeds to step 158. In step 158, method 100 returns return values R1 and R2 to calling program 42. Method 100 then ends.

Return value R1 returned by method 100 to calling program 42 indicates whether, when data D1 and D2 passed to method 100 in step 102 are compared according to dictionary sort order table 46, (i) datum D1 has a lower weight than datum D2; (ii) datum D2 has a lower weight than datum D1; or (iii) data D1 and D2 have the same weight and are in the same equivalence. If return value R1 indicates that data D1 and D2 are in the same equivalence class, then return value R2 indicates whether, when data D1 and D2 are compared according to dictionary sort order table 48, (i) datum D1 has a lower weight than datum D2; (ii) datum D2 has a lower weight than datum D1; or (iii) data D1 and D2 have the same weight. In this exemplary embodiment, when the value of return value R1 is D1 or D2, then the value of return value R2 is not calculated by method 100.

In an alternative embodiment of the present invention, return value R2 may be calculated regardless of the value of return value R1. To implement this option, method 100 would proceed from step 122, 124, 128 or 130 to step 140, rather than to step 132. Return values R1 and R2 are returned to calling program 42 together in step 158.

Table 1 illustrates the results of method 100 when each combination of the data chad, Alpha, CHAD, delta, and Chad is passed to method 100 as data D1 and D2 in step 102.

TABLE 1

| D1 | D2 | R1 | R2 |
|---|---|---|---|
| chad | Alpha | D2 | — |
| chad | CHAD | EQ | D2 |
| chad | delta | D1 | — |
| chad | Chad | EQ | D2 |
| Alpha | CHAD | D1 | — |
| Alpha | delta | D1 | — |
| Alpha | Chad | D1 | — |
| CHAD | delta | D1 | — |
| CHAD | Chad | EQ | D1 |
| Delta | Chad | D2 | — |

Depending on the sorting algorithm implemented in sorting module 44, sorting module may call comparison module 52 and pass it some or all of the combinations of data D1 and D2 set out in Table 1. Sorting module 44 uses return values R1 and R2 from comparison module 52 to organize the character strings in output data set in the order set out in Table 2. Character strings chad, Chad, and CHAD are listed consecutively, since the are in the same equivalence class. The order of these strings in output data list 62 is controlled by the unique collating sequence defined in dictionary sort order table 48.

TABLE 2

“Alpha”
“CHAD”
“Chad”
“chad”
“delta”

In another embodiment of the present invention, a sorting module 44 may be configured to provide an output data set 62 in which duplicate data in the same equivalence class have been eliminated so that only one datum from each equivalence class, according to dictionary sort order table 46, is included. Such a sorting module 44 would use return values R1 to identify duplicate members of a single equivalence class. The sorting module 44 may be configured to select one member of the equivalence class for inclusion in the output data 62 on any basis. The one member may be selected at random, based on the order in which the members of the equivalence class appear in the input data set 60, or return values R2 may be used to select the member of the equivalence class with the lowest (or highest) collating weight according to dictionary sort order table 48.

An embodiment of the present invention based on sorting English language words or character strings has been described. The invention may be modified by a skilled person to be used to sort word or character strings in any other language by configuring dictionary sort order tables 46 and 48.

In addition, the present invention may be modified to provide multi-level sorting between character strings formed of symbols or other indicia by similarly configuring dictionary sort order tables 46 and 48.

It will be appreciated that variations of some elements are possible to adapt the invention for specific conditions or functions. The concepts of the present invention can be further extended to a variety of other applications that are clearly within the scope of this invention. Having thus described the present invention with respect to a preferred embodiments as implemented, it will be apparent to those skilled in the art that many modifications and enhancements are possible to the present invention without departing from the basic concepts as described in the preferred embodiment of the present invention. Therefore, what is intended to be protected by way of letters patent should be limited only by the scope of the following claims.

What is claimed is:

1. A method for ordering a first character string and a second character string comprising the steps of:
(a) determining which of the first character string and the second character string has a lower collating weight according to a first dictionary sort order table with a non-unique collating sequence; and
(b) determining which of the first character string and the second character string has a lower collating weight according to a second dictionary sort order table with a unique collating sequence.

2. The method of claim 1, wherein if the collating weight according to the non-unique collating sequence of the first character string is equal to that of the second character string, the first character string and the second character string are in a single equivalence class.

3. The method of claim 2, wherein step (b) is performed only if the first and second character strings are in the single equivalence class.

4. The method of claim 1, wherein determining step (a) comprises:
(a1) comparing a non-unique collating weight according to the first dictionary sort order table of a first character of the first character string to that of a first character of the second character string;
(a2) if the non-unique collating weight of the first character string's first character is equal to that of the second character string's first character, determining whether the first character string and the second character string are in a single equivalence class;
(a3) if the non-unique collating weight of the first character string's first character is less than that of the second character string's first character, ordering the first character string before the second character string; else
(a4) ordering the second character string before the first character string.

5. The method of claim 4, wherein determining step (a2) comprises:
(a2i) determining whether a next character in the first character string exists and whether a next character in the second character string exists;
(a2ii) if the next character of the first character string does not exist, and the next character in the second character exists, ordering the first character string before the second character string;
(a2iii) if the next character of the second character string does not exist, and the next character in the first character exists, ordering the second character string before the first character string; else
(a2iv) if the next character of the first and second character strings do not exist, designating the first and second character strings in the single equivalence class; else
(a2v) comparing the non-unique weight for the first character string's next character to that of the second character string's next character;
(a2vi) if the non-unique weight for the first character string's next character is equal to that of the second character string's next character, repeating steps (a2i) through (a2vi);
(a2vii) if the non-unique weight for the first character string's next character is less than that of the second character string's next character, ordering the first character string before the second character string; else
(a2viii) ordering the second character string before the first character string.

6. The method of claim 3, wherein the determining step (b) comprises:
(b1) comparing a unique collating weight according to the second dictionary sort order table of a first character of the first character string to that of a first character of the second character string;
(b2) if the unique collating weight of the first character string's first character is equal to that of the second character string's first character, determining whether the first character string and the second character string are equivalents;
(b3) if the unique collating weight of the first character string's first character is less than that of the second character string's first character, ordering the first character string before the second character string within the single equivalence class; else
(b4) ordering the second character string before the first character string within the single equivalence class.

7. The method of claim 6, wherein determining step (b2) comprises:
(b2i) determining whether a next character in the first and second character strings exist;
(b2ii) if the next character exists, comparing the unique weight for the first character string's next character to that of the second character string's next character;
(b2iii) if the unique weight for the first character string's next character is equal to that of the second character string's next character, repeating steps (b2i) through (b2iii);
(b2iv) if the unique weight for the first character string's next character is less than that of the second character string's next character, ordering the first character string before the second character string within the single equivalence class;
(b2v) if the unique weight for the second character string's next character is less than that of the first character string's next character, ordering the second character string before the first character string within the single equivalence class; else
(b2vi) designating the first and second characters stings as equivalents.

8. The method of claim 1, further comprising the steps of:
(c) receiving the first and second character strings from an invoking module; and
(d) returning results from determining steps (a) and (b) to the invoking module.

9. The method of claim 1, wherein the unique collating sequence is case sensitive.

10. The method of claim 1, wherein the non-unique collating sequence is case insensitive.

11. A computer readable medium containing programming instructions for ordering a first character string and a second character string comprising instructions for:
(a) determining which of the first character string and the second character string has a lower collating weight according to a first dictionary sort order table with a non-unique collating sequence; and
(b) determining which of the first character string and the second character string has a lower collating weight according to a second dictionary sort order table with a unique collating sequence.

12. The computer readable medium of claim 11, wherein if the collating weight according to the non-unique collating sequence of the first character string is equal to that of the second character string, the first character string and the second character string are in a single equivalence class.

13. The computer readable medium of claim 12, wherein determining instruction (b) is performed only if the first and second character strings are in the single equivalence class.

14. The computer readable medium of claim 11, wherein determining instruction (a) comprises:
(a1) comparing a non-unique collating weight according to the first dictionary sort order table of a first character of the first character string to that of a first character of the second character string;
(a2) if the non-unique collating weight of the first character string's first character is equal to that of the second character string's first character, determining whether the first character string and the second character string are in a single equivalence class;
(a3) if the non-unique collating weight of the first character string's first character is less than that of the second character string's first character, ordering the first character string before the second character string; else
(a4) ordering the second character string before the first character string.

15. The computer readable medium of claim 14, wherein determining instruction (a2) comprises:
(a2i) determining whether a next character in the first character string exists and whether a next character in the second character string exists;
(a2ii) if the next character of the first character string does not exist, and the next character in the second character exists, ordering the first character string before the second character string;
(a2iii) if the next character of the second character string does not exist, and the next character in the first character exists, ordering the second character string before the first character string; else
(a2iv) if the next character of the first and second character strings do not exist, designating the first and second character strings in the single equivalence class; else
(a2v) comparing the non-unique weight for the first character string's next character to that of the second character string's next character;
(a2vi) if the non-unique weight for the first character string's next character is equal to that of the second character string's next character, repeating instructions (a2i) through (a2vi);
(a2vii) if the non-unique weight for the first character string's next character is less than that of the second character string's next character, ordering the first character string before the second character string; else
(a2viii) ordering the second character string before the first character string.

16. The computer readable medium of claim 13, wherein the determining instruction (b) comprises:
(b1) comparing a unique collating weight according to the second dictionary sort order table of a first character of the first character string to that of a first character of the second character string;
(b2) if the unique collating weight of the first character string's first character is equal to that of the second character string's first character, determining whether the first character string and the second character string are equivalents;
(b3) if the unique collating weight of the first character string's first character is less than that of the second character string's first character, ordering the first character string before the second character string within the single equivalence class; else
(b4) ordering the second character string before the first character string within the single equivalence class.

17. The computer readable medium of claim 16, wherein determining instruction (b2) comprises:
(b2i) determining whether a next character in the first and second character strings exist;
(b2ii) if the next character exists, comparing the unique weight for the first character string's next character to that of the second character string's next character;
(b2iii) if the unique weight for the first character string's next character is equal to that of the second character string's next character, repeating instructions (b2i) through (b2iii);
(b2iv) if the unique weight for the first character string's next character is less than that of the second character string's next character, ordering the first character string before the second character string within the single equivalence class;
(b2v) if the unique weight for the second character string's next character is less than that of the first character string's next character, ordering the second character string before the first character string within the single equivalence class; else
(b2vi) designating the first and second characters stings as equivalents.

18. The computer readable medium of claim 1, further comprising instructions for:
(c) receiving the first and second character strings from an invoking module; and
(d) returning results from determining steps (a) and (b) to the invoking module.

19. The computer readable medium of claim 11, wherein the unique collating sequence is case sensitive.

20. The computer readable medium of claim 11, wherein the non-unique collating sequence is case insensitive.

21. A method for sorting an input data list comprising a plurality of character strings, the method comprising the steps of:
(a) selecting a first character string and a second character string from the plurality of character strings;
(b) comparing the first character string to the second character string according to a first dictionary sort order table with a non-unique collating sequence;
(c) comparing the first character string to the second character string according to a second dictionary sort order table with a unique collating sequence;
(d) selecting a different pair of first and second character strings in accordance with a sorting algorithm;
(e) repeating steps (a) through (d) iteratively;
(f) sorting the character strings into at least one equivalence class based on comparing step (b); and
(g) sorting the character strings within the at least one equivalence class based on comparing step (c).

22. The method of claim 21, wherein comparing step (b) is performed to determine whether the first character string has a lower collating weight than that of the second character string according to the non-unique collating sequence of the first dictionary sort order table, whether the second character string has a lower collating weight than that of the first character string, and whether the collating weight of the first character string is equal to that of the second character string.

23. The method of claim 22, wherein the sorting step (f) comprises:
(f1) grouping the first and second character strings into an equivalence class if the collating weight according to the non-unique collating sequence of the first character string is equal to that of the second character string.

24. The method of claim 21, wherein comparing step (c) is performed to determine whether the first character string has a lower collating weight than the second character string according to the unique collating sequence of the second dictionary sort order table, whether the second character string has a lower collating weight than the first character string, and whether the collating weight according to the unique collating sequence of the first and second character strings are equal.

25. The method of claim 23, wherein step (c) is performed only if the first and second character strings are in the same equivalence class.

26. The method of claims 21, further comprising:
(h) receiving the input data list from a calling program; and
(i) passing the sorted character strings to the calling program as an output data list.

27. The method of claim 21, wherein the unique collating sequence is case sensitive.

28. The method of claim 21, wherein the non-unique collating sequence is case insensitive.

29. A computer readable medium containing program instructions for sorting an input data list comprising a plurality of character strings, comprising the instructions for:
(a) selecting a first character string and a second character string from the plurality of character strings;
(b) comparing the first character string to the second character string according to a first dictionary sort order table with a non-unique collating sequence;
(c) comparing the first character string to the second character string according to a second dictionary sort order table with a unique collating sequence;
(d) selecting a different pair of first and second character strings in accordance with a sorting algorithm;
(e) repeating instructions (a) through (d) iteratively;
(f) sorting the character strings into at least one equivalence class based on comparing instructions (b); and
(g) sorting the character strings within the at least one equivalence class based on comparing instructions.
